(19) United States
(12) Patent Application Publication
(10) Pub. No.: US 2009/0120961 A1
(43) Pub. Date: May 14, 2009

(54) Multiple Chilled Alcoholic Beverages Dispenser System

(75) Inventors: Eric Dietschi, Chardonne (CH); Eric Fournier, Saint Sylvestre Pragoulin (FR); Alexandre Pereira, Valence (FR)

Correspondence Address: HOFFMANN & BARON, LLP, 6900 JERICHO TURNPIKE, SYOSSET, NY, 11791, US

(73) Assignee: DIEAU-EDAFIM, Le Pouzin (FR)

(21) Appl. No.: 11/920,650

(22) PCT Filed: May 19, 2005
(86) PCT No.: PCT/IB2005/001794

§ 371 Date: Jul. 23, 2008

(51) Int. Cl. B67D 5/62; F25B 21/02

(52) U.S. Cl. 222/146.6; 62/3.2

(57) ABSTRACT

The present invention relates to a multiple chilled alcoholic beverages dispenser system comprising: at least two independent sources of alcoholic beverage each stored in a separate container (29, 26); a cooling system (10, 23, 27, 29) through which the at least two independent sources of alcoholic beverage pass (29) before dispensing; and dispenser means (13a, 13b) wherein the cooling system comprises a single chamber (10) through which the at least two independent sources of alcoholic beverage pass before reaching the dispenser means.

The present invention relates to a dispenser system for dispensing multiple, chilled alcoholic beverages. Dispensing systems for alcoholic beverages have been known for a long time, and many solutions have previously been proposed to try and solve the problems associated with chilling and maintaining the temperature of the chilled alcoholic beverage so that the customer obtains a satisfactorily chilled drink. Such systems have previously been known to include a source of alcoholic beverage, a chilling means, and a means for dispensing the chilled beverage.

Generally, the source of alcoholic beverage is supplied in a suitable container, for example in a bottle, a canister, or “bag-in-box”, i.e. a box-like outer structure often made of cardboard, and comprising a flexible envelope located within the cardboard outer, and within which envelope the alcohol beverage, for example wine, is stored.

Classically, the beverage has been known to be chilled after dispensing by direct chilling, for example, by the addition of ice cubes to the beverage once poured. Other methods of chilling are also known, for example, by placing the container in which the alcoholic beverage is stored into a domestic or industrial refrigerator chamber, and then withdrawing the beverage from the container upon demand. The problems associated with such a means of chilling and dispensing are also well known, in that, repeated withdrawal of the container from the refrigerator chamber causes the temperature of the alcoholic beverage to rise the more often that drink is dispensed. Such a solution also has the inherent problems associated with storage of the beverage in a location that may be needed for storage of other products such as food.

Another solution, for example, in the case of beer, has been to provide the beer in a vat under pressure. The beer, often stored in a beer cellar, is connected via conduits to a pump, and the connecting conduits may or may not be refrigerated. When several beers are to be proposed, it is often necessary for each one to have a separate pump and a separate refrigerating mechanism so that the beers are not mixed and can be served at a correctly chilled temperature. This adds to the complexity and maintenance of such systems, but also does not necessarily guarantee that the beer is served at the correct temperature, depending on the distance that the beer has to travel from the container to the dispenser.

One way around these problems has been to propose all-in-one devices that cool the beverage. For example, with bag-in-box solutions, such dispensers generally comprise a small refrigerating unit disposed above or below the outer box structure, and through which the beverage is made to pass or is with which the beverage is brought into contact in order to chill the alcoholic beverage, which in this case is most often wine. In this way, the wine can be chilled before serving simply by placing the box in position onto or beneath the refrigeration unit. There still remains, however, the problem of providing a dispenser that can store multiple alcoholic beverages, provide refrigeration for said beverages, and provide distribution of said beverages, all in one single, compact apparatus, that can be sat on top of a bar surface, for example.

The present inventors have surprisingly discovered that it is possible to provide a dispenser system for chilled alcoholic beverages that will permit dispensing of two or more alcoholic beverages at the same time, and which remains nonetheless compact, easy to maintain, and easy to operate, while providing the alcoholic beverages at the desired chilled temperature.

Consequently, one object of the present invention is a multiple chilled alcoholic beverages dispenser system comprising:
at least two independent sources of alcoholic beverage each stored in a separate container;
a cooling system through which the at least two independent sources of alcoholic beverage pass before dispensing; and
dispenser means,
wherein the cooling system comprises a single chamber through which the at least two independent sources of alcoholic beverage pass before reaching the dispenser means.

Preferably, the at least two independent sources of alcoholic beverage are selected from the group consisting of bottles, canisters, sachets, cans, boxes, and are preferably both bottles.

In yet another preferred embodiment of the invention, the single chamber of the cooling system comprises an ice bank generator as primary source of cold, preferably an evaporator. Even more preferably, the single chamber of the cooling system contains at least one eutectic solution with a freezing point comprised between about −4° C. to about −20° C. Eutectic solutions that freeze at this temperature are well known in the art, and commercially available. Examples of such a solution are Temper −10° C., or Temper −20° C., distributed by Dehon, France. The evaporator coil is preferably located at the bottom of the single chamber, with the major volume of the chamber located above it. When the evaporator coil is brought into operation, ice tends to form above or around the coil, in what is known as an ice bank. The ice bank is made up of crystals of at least one frozen eutectic solution. The remainder of the at least one eutectic solution that is still in liquid form in the chamber is preferably circulated over the ice bank that forms, thereby maintaining a low temperature of said solution. In order to circulate said solution within the chamber, two pumps are most preferably provided that cause the solution to be directed over the bank of ice located above the evaporator coil at the bottom of the chamber, and from there into an upper zone of the cooling chamber.

In another preferred embodiment, the single chamber of the cooling system comprises a Peltier plate. These are thermoelectric devices, also well known per se in the art, that produce a temperature differential via metals having different electrical resistances or conductivities. The Peltier plate can also be located at the bottom of the single chamber, the coldest face of the plate facing upward toward the major volume of the chamber. Since one side of the plate is much colder than the other, ice tends to form on that side of the plate, as an ice bank, in a similar manner to the evaporator coil.

In still yet another preferred embodiment, the beverage sources each have an outlet that is located at a position above an uppermost limit of the cooling system. In this way, the beverages can simply leave the beverage source under the effect of gravity. However, in a most preferred embodiment, the beverage sources are forced into the cooling system by forced introduction of air into the beverage sources. Such forced introduction of air into the beverage sources can be provided by at least one air pump, preferably an air pump for each beverage source. In this way, when beverage is to be introduced into the cooling system, air is forced into the beverage source, for example a bottle, and the pressure increase within the bottle causes the beverage therein to be forced out into the cooling system.

In another even more preferred embodiment, each beverage source is connected to a separate cooling coil, and each separate coil passes through the single chamber. In this manner, each beverage is cooled in a separate cooling circuit that is located in the single cooling chamber. The cooling coils are located in the single chamber above the evaporator coil or Peltier plate, and therefore above the ice bank that forms within the chamber. In a most preferred embodiment of the invention, and one that has been found to be particularly advantageous, the cooling coils are arranged side by side in the cooling chamber, i.e. each coil occupies approximately half of the free volume remaining in the chamber. It is to be understood in the present specification that the “free volume” of the cooling chamber refers to the total volume minus the volume occupied by the evaporator coil or Peltier plate and the ice bank. In order to facilitate location of the cooling coils in the single chamber, a shoulder or baffle can be provided in a lower zone of said chamber that projects from one of the peripheral walls of said chamber into said chamber, but which still leaves access to the evaporator coil or Peltier plate located at the bottom of said chamber. In this way, the cooling coils can simply rest on the shoulder or baffle plate and do not need to be maintained or suspended by brackets or other suspension means. Alternatively and in another embodiment, the cooling coils can be arranged coaxially, a first inner coil being located with the volume defined by a second, outer coil, along a vertical or horizontal axis of the single chamber.

Preferably, the beverage sources used in the invention are bottles and are connected via a respective and corresponding feed tube to the cooling coils passing through the cooling system. Even more preferably, an air filter for and connected to each feed tube is provided, enabling air to enter each respective bottle when beverage leaves or is withdrawn from the bottles. A non-return valve is preferably also provided between the air filter and the feed tube, thereby preventing any beverage from reaching the air filter.

In still yet another preferred embodiment, a female-female adapter is fitted sealingly around and over the feed tube at one extremity of said adapter, and sealingly receives a bottle neck and head of the beverage source at the other extremity of said adapter. The female-female adapter sealing engages the bottle neck and head, thereby preventing beverage from escaping to any undesirable location outside of the system. A tight seal can be ensured by providing one or two, preferably two, O-ring seals within the extremity of the adapter that receives the bottle neck and head. The adapter is fitted with a mechanism to control beverage flow into the cooling system, for example, by providing a ball valve mechanism. Other valves could also be envisaged, for example, electrically actuated valves, or other well known types of membrane that function in an equivalent manner.

In order to maintain a tight and correct connection between the female-female adapter and the bottle, a threading can preferably be located within the adapter or within the integrated sleeve of the feed tube. This threading can correspond to the equivalent screw threading that is provided on many bottle necks or other containers, such as certain drink canisters, thereby enabling the bottle, canister or container equipped with a screw-threaded head to be screwed into place in the adapter, limiting movement thereof and improving the seal between the container and the adapter.

In an alternative and preferred embodiment, the feed tube comprises an integrated outer sleeve connected to an annular base skirt, and an inner sleeve that sealingly receives a bottle neck and head. In such an embodiment, there is no longer any female-female adapter, and the feed tube connects directly with the bottle. The outer sleeve extends from the base skirt that is located substantially half-way along the length of the feed tube. The inner sleeve does not need to be equipped with a screw thread for receiving beverage source. The outer sleeve can additionally and preferably have an annular inward projection or lip, that is even more preferably angled, to guide the beverage source container, for example, a bottle neck, into a mating configuration within the inner sleeve, and to prevent any splashing or spilling of beverage outside of the feed tube. The feed tube also preferably comprises a bevelled piercing tip located within the inner sleeve, and which is aligned in an axial extension of said feeder tube. The inner sleeve extends beyond the bevelled piercing tip so as to form a tight seal with the bottle neck by means of O-ring seals provided within the inner sleeve. The annular lip at of the outer sleeve helps to guide the bottle neck onto the piercing tip. The alternative feed tube embodiment is particularly useful when the bottle has a cap and a tamper membrane located across the opening of the bottle and placed between the cap and said opening in order to maintain hygiene and show that the bottle has not been tampered with before use. In use the cap is removed, and the bottle inserted into the into outer, and then inner sleeve. The bottle head and neck will slide into the inner sleeve, guided by the annular lip of the outer sleeve, until the head comes to rest on an annular shoulder connecting the feeder tube to the inner sleeve. The O-ring seals present, preferably two O-ring seals, will provide for elastic sealtight maintenance of the bottle in position. Since the feed tube comprises a bevelled piercing tip, the tip will come into contact with the membrane and pierce the latter thereby enabling fluid connection between the feed tube and the beverage source.

The present invention will now be described in more detail with reference to some preferred modes of execution, and the drawings, in which:

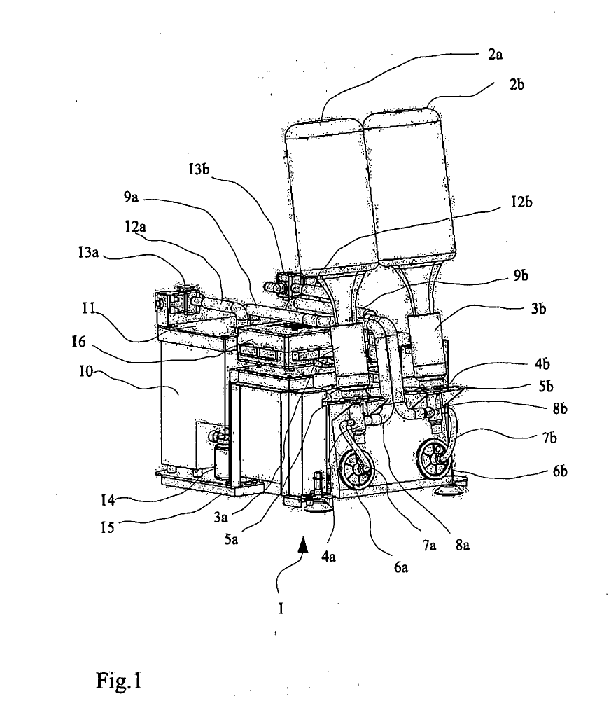

FIG. 1 represents a rear perspective view of a preferred chilled alcoholic beverage dispenser system according to the invention;

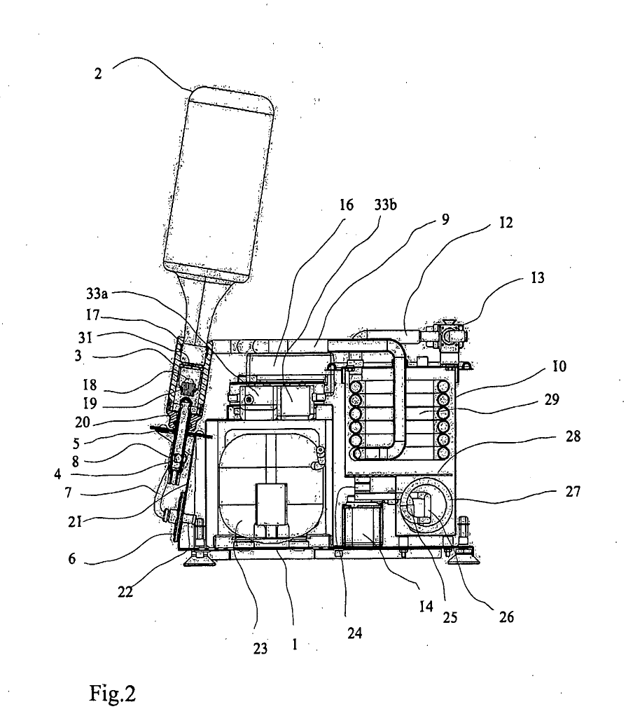

FIG. 2 represents a cross-sectional view of the dispenser of FIG. 1;

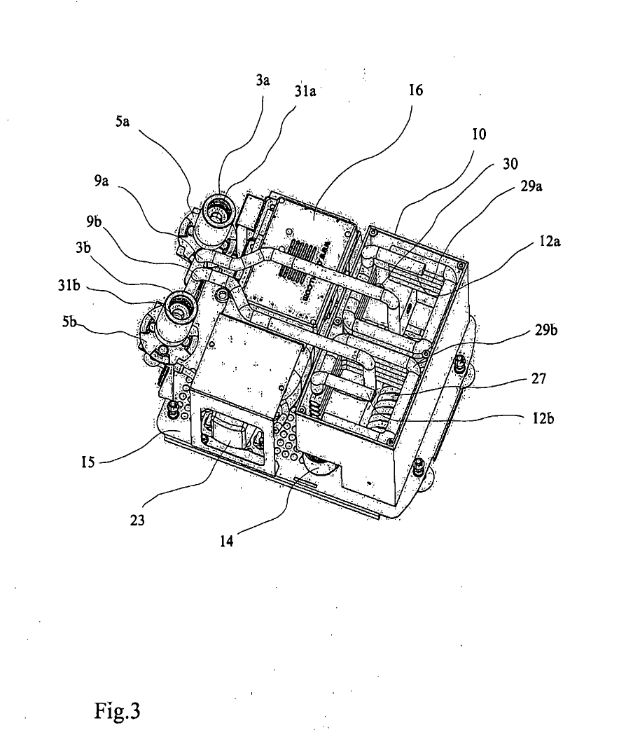

FIG. 3 represents a top perspective view of the dispenser of FIG. 1 with a cooling system cover plate removed;

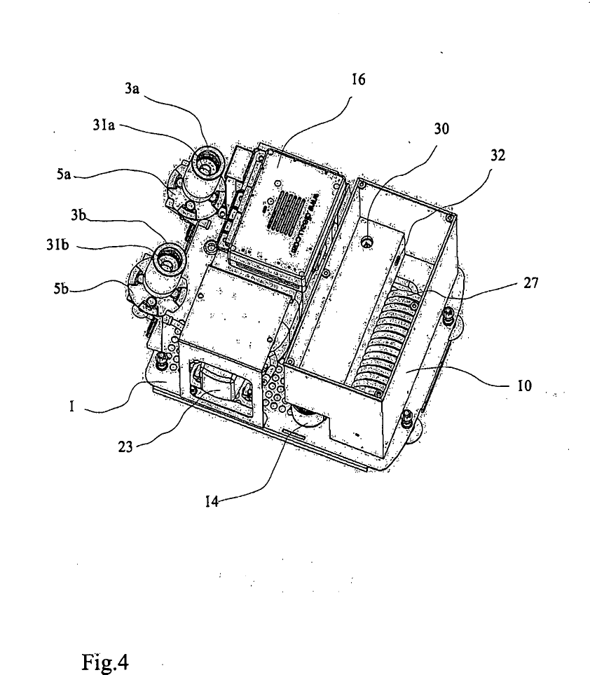

FIG. 4 represents substantially the same view as FIG. 3, except that the cooling coils have been removed to display the ice bank generator as the primary source of cold at the bottom of the cooling chamber;

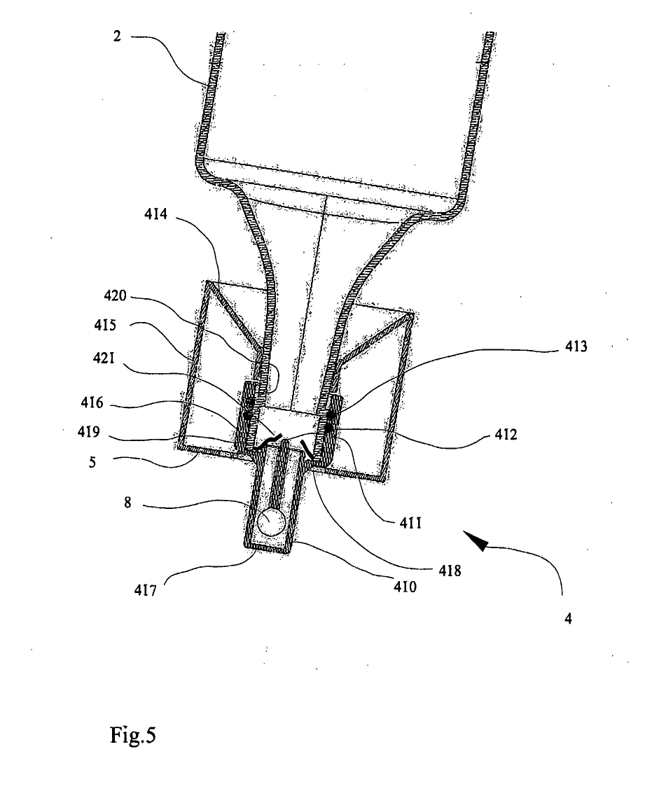

FIG. 5 represents a particularly preferred alternative embodiment of the feeder tubes used in the system of the present invention;

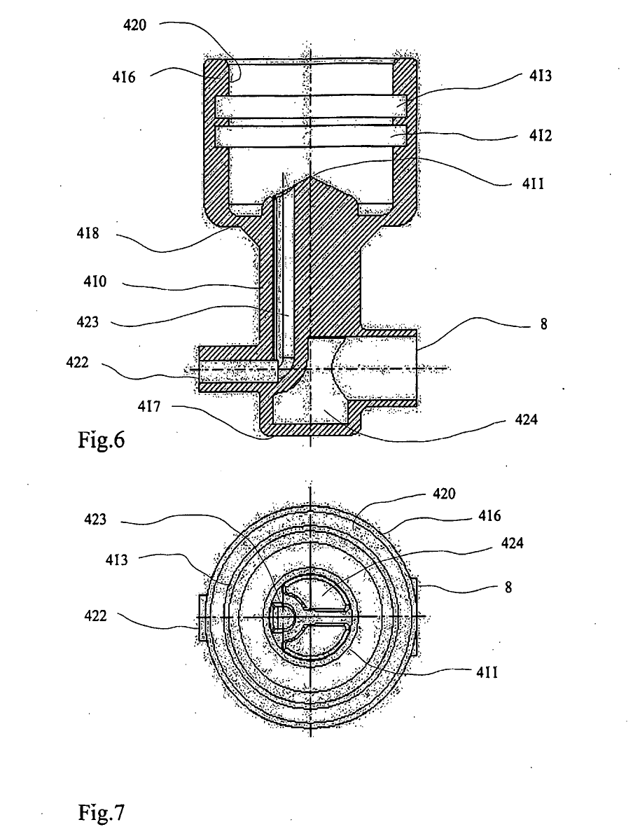

FIGS. 6 and 7 represent respectively a cross-sectional view of a detail of the feeder tube of FIG. 5 along its longitudinal axis, and a cross-sectional view orthogonal to the longitudinal axis of the tube, i.e. the appearance of the tube when looking from above down through said tube.

Turning now to FIG. 1, a chilled alcoholic beverage dispenser system according to the invention is represented generally by the reference numeral 1. The dispenser comprises two alcoholic beverage sources 2a, 2b, in this case two bottles of alcohol, for example, spirit, fortified wine, beer, or the like, that are located substantially above the dispenser 1. The bottles are connected to the dispenser 1 via an adapter 3a, 3b, in which the necks of the bottles are received in a sealtight manner. The adapters 3a,3b are in turn connected to feed tubes 4a,4b. The feed tubes have a base skirt 5a,5b located approximately half-way along the length of the tube, which provides a stop for the sliding insert of the adapters 3a,3b onto the tubes 4a,4b. The feed tubes 4a,4b are connected to corresponding air filters 6a,6b and ducts 7a,7b, enabling filtered air to enter the bottles 2a,2b via the feed tubes 4a,4b and adapters 3a,3b. Preferably, non-return valves are provided between the air filters 6a,6b and the ducts 7a,7b. The feed tubes 4a,4b are also connected to beverage outlet ducts 8a,8b, that carry the beverages separately and independently to separate cooling coil inlets 9a,9b. These cooling coil inlets then disappear into a cooling chamber 10, in which the cooling system and cooling coils are located. The cooling chamber 10 has a removable cover plate 11, to facilitate access to the chamber and thereby maintenance of the cooling coils, primary cold source generator, and eutectic solutions stored therein. Two chilled beverage outlet ducts 12a,12b emerge through the cover plate 11 and are connected to two corresponding electrically actuated valves 13a,13b.

The valves 13a,13b are connected to taps or spigots (not shown) and are actuated when it is desired to dispense one or more of the chilled alcoholic beverages. Alternatively, the valves can also be replaced by a nip feed system, that can either be manual, i.e. mechanical, or electrically actuated, whereby the chilled beverage passes through a duct that can be opened or closed as desired using, for example, a nip roller mechanism. Typically in such a mechanism, a first roller is brought to impinge on another roller or pair of rollers thereby blocking flow of beverage. Equivalent systems using metal or plastic blocks that interlock are also known and can be used instead of the roller mechanism. Also shown in FIG. 1 is a pump 14, that circulates eutectic solution within the cooling chamber, and a base plate 15 to which forms the foundation for the dispenser according to the present invention, and to which the major components are directly attached. A control unit 16 is provided that deals with regulating the temperature, and controlling the electrical circuitry of the device, including, for example, tracking the number of beverage doses dispensed, maintenance intervals, and the like.

FIG. 2 is a cross-section of the system represented in FIG. 1. The same references designate the same elements of FIG. 1 except that no differentiation is made between an element (a) or (b) of the same reference numeral. The adapter 3 is fitted with O-ring seals 17 to ensure a sealtight fit of the bottle 2. In addition, a suspended flexible membrane 19 fitted with a ball 18 forms a valve in the adapter 3 enabling regulation of the flow of beverage into the feeder tube. The bottle head rests on an annular shoulder 31 that projects from the adapter wall into the adapter volume, leaving an opening that corresponds in diameter substantially to that of the opening of the bottle. In this way, alcoholic beverage from the bottle does not flow all over the inside of the adapter or leak out. This is a particularly advantageous configuration for alcoholic beverages with a relatively high sugar content, such as in fortified wines, since it effectively avoids deposition of excess beverage in the adapter, thereby avoiding build up of sirupy residues that could make it difficult to fit subsequent bottles onto the adapter. This figure also illustrates the presence of air pumps 33a,33b, which are connected to the air filters 6a,6b respectively, and enable filtered air to be forced into the beverage sources via the feed tubes 4a,4b, for example bottles, thereby forcing beverage back into the feed tubes and into the cooling system via outlets 8a,8b, and inlets 9a,9b.

The beverage from the bottle flows down through the adapter 3, through the feeder tube 4 and into the outlet 8. This outlet is connected to the cooling coil inlet 9, which is in turn connected to a cooling coil 29. Each cooling coil 29 is located in the cooling chamber 10 and rests substantially on a shoulder 28 provided in the chamber that projects into the volume of said chamber. The shoulder 28 also helps keep the cooling coils 29 separated from the ice bank that forms in the eutectic solution. The chamber is also equipped with a primary cold source generator 27, in this example an evaporator coil 27 that is connected to a compressor 23. The evaporator coil 27 generates a source of primary cold, that in turn cools the eutectic solution held within the chamber. Directly above the evaporator coil 27, an ice bank tends to form and this accentuates the transfer of cold with the eutectic solution which is cause to circulate around the chamber 10 by means of a pump 14. The pump 14 withdraws eutectic solution from the chamber 10 via a duct 24 and an outlet orifice 32 (see FIG. 4) located near the bottom of the chamber 10. The eutectic solution is then pumped back into the chamber 10 via duct 24 and inlet orifice 30, located at a position higher up in the chamber, and preferably, as illustrated in FIGS. 3 and 4, located in the shoulder 28. In this manner eutectic solution is circulated in the chamber from the bottom to the top, causing a flow of colder eutectic solution to move over the cooling coils 29. As energy is exchanged with the cooling coils, so the beverage cools, and so the eutectic solution should warm up. However, since the eutectic solution is pumped around the chamber and is in continuous contact with the ice bank, it remains at substantially the same temperature throughout.

FIG. 3 shows a top perspective view of the system illustrated in FIG. 1 with the cover plate removed so that the cooling coils 29a,29b, and the evaporator 27 are visible. From this Figure, one can see how the cooling coils 29a,29b are located side by side in the chamber 10, and how they rest on the shoulder 28, which effectively projects into the volume of the chamber from one of the peripheral walls of the latter, effectively separating the evaporator 27 from the cooling coils, so that they do not come into direct contact with each other, and still leaving enough volume for an ice bank to form and permit circulation of eutectic solution.

FIG. 4 illustrates the same system as in FIG. 3, but with the inlet ducts 9a,9b and coils 29a,29b removed, as would be the case for example, when maintenance is carried out on the system. One can easily comprehend that the system is also easy to maintain and highly modular.

FIG. 5 illustrates a cross-section of a particularly preferred alternative embodiment of the feeder tube used in the system of the present invention and generally indicated by the reference numeral 4. The feeder tuber 4 can be made of molded plastic, for example, polyethylene, polypropylene, or any other suitable plastic material that is suitable for contact with alcoholic beverages, and comprises an annular base skirt 5, a feed tube proper 410, the lower extremity 417 of which is closed. The feed tube 410 has a beverage outlet 8, through which beverage flows to the cooling system of the dispenser of the invention. The tube 410 extends upwards towards, through, and above the base skirt 5, and comprises an annular shoulder 418, connected to the tube 410, that rests on the base skirt 5. The feeder tube 4 comprises two sleeves, an outer sleeve 415 connected or integrated to the annular base skirt 5, which projects upwards from the periphery of the skirt 5 over. At an upper extremity of the outer sleeve 415 there is an annular lip 414 that may be angled downwards towards an inner sleeve 416 of the feeder tube. The inner sleeve 416 extends upwards from the annular shoulder 418, towards the annular lip 414 of the outer sleeve 415. The purpose of the annular lip 414 is to help guide and stabilize a bottle neck that is being inserted onto the feeder tube. It also serves to help position the bottle head 419 within the inner sleeve 416. The inner sleeve is provided with two O-ring seals 412, 413, located on the inner wall 420 of said sleeve 416. Formed within the tube proper 410 is a bevelled piercing tip 411. As the bottle head 419 is engaged in the inner sleeve, so the piercing tip will pierce a membrane 421 that can be provided on the bottle head to demonstrate that the bottle has not been tampered with. When the tip 411 pierces the membrane 421, the membrane is broken and beverage will now be able to flow into the feed tube 410 and into the cooling system via outlet 8. In the preferred embodiment of the invention, this occurs when the electrically actuated valve 13 is actuated by an operator, which in turn activates the air pump 33, injecting air via the air filter 6 into the bottle 2, thereby flushing beverage into the feeder tube and cooling system.

FIGS. 6 and 7 are different cross-sections of the inner sleeve of the feeder tube of FIG. 5, and show the arrangements of an air inlet 422 and air inlet conduit 423 within the feeder tube 410 and the beverage conduit 424 and beverage outlet 8.

1. A multiple chilled alcoholic beverages dispenser system comprising:
at least two independent sources of alcoholic beverage each stored in a separate container;
a cooling system through which the at least two independent sources of alcoholic beverage pass before dispensing; and
dispensing means,
wherein the cooling system comprises a single chamber through which the at least two independent sources of alcoholic beverage pass before reaching the dispenser means.

2. A dispenser system according to claim 1, wherein the at least two independent sources of alcoholic beverage are selected from the group consisting of bottles, canisters, sachets, cans, boxes.

3. A dispenser system according to claim 1, wherein the single chamber of the cooling system comprises an ice bank generator as primary source of cold.

4. A dispenser system according to claim 1, wherein the single chamber of the cooling system contains at least one eutectic solution with a freezing point comprised between about −4° C. to about −20° C.

5. A dispenser system according to claim 1, wherein the single chamber of the cooling system comprises an evaporator coil as the ice bank generator.

6. A dispenser system according to claim 1, wherein the single chamber of the cooling system comprises a Peltier plate as the ice bank generator.

7. A dispenser system according to claim 1, wherein the single chamber of the cooling system comprises at least two pumps for circulating at least one eutectic solution around the chamber.

8. A dispenser system according to claim 1, wherein the beverage sources each have an outlet that is located at a position above an uppermost limit of the cooling system.

9. A dispenser system according to claim 1, wherein each beverage source is connected to a separate cooling coil, and each separate coil passes through the single chamber.

10. A dispenser system according to claim 9, wherein the cooling coils are arranged side by side in the cooling chamber.

11. A dispenser system according to claim 9, wherein the cooling coils are arranged coaxially, a first inner coil being located within the volume defined by a second, outer coil, along a vertical or horizontal axis of the single chamber.

12. A dispenser according to claim 1, wherein the beverage sources are bottles and are connected via a respective and corresponding feed tube to cooling coils passing through the cooling system.

13. A dispenser system according to claim 12, further comprising an air filter for and connected to each feed tube, enabling air to enter each respective bottle when beverage leaves each said bottle.

14. A dispenser system according to claim 12, wherein a female-female adapter is fitted sealingly around and over the feed tube at one extremity of said adapter, and sealingly receives a bottle neck and head of the beverage source at the other extremity of said adapter.

15. A dispenser system according to claim 14, wherein the female-female adapter comprises a ball valve mechanism for controlling the flow of beverage into the feed tube.

16. A dispenser system according to claim 15, wherein the beverage source is received via a threading located within the adapter.

17. A dispenser system according to claim 12, wherein the feed tube comprises an integrated inner sleeve that sealingly receives a bottle neck and head.

18. A dispenser system according to claim 17, wherein the feed tube comprises a beveled piercing tip located within the integrated sleeve.

19. A dispenser system according to claim 17, wherein the feed tube also comprises an outer sleeve with an annular bottle guide lip.

20. A dispenser system according to claim 17, wherein the inner sleeve is provided with at least one O-ring seal.

21. A dispenser system according to claim 17, wherein the inner sleeve extends upwards towards an annular lip of the outer sleeve.
